(19) United States
(12) Patent Application Publication
(10) Pub. No.: US 2014/0334696 A1
(43) Pub. Date: Nov. 13, 2014

(54) CLOUD-BASED METHOD AND SYSTEM FOR DIGITAL PATHOLOGY

(71) Applicant: OPTRA SYSTEMS INC., Santa Clara, CA (US)

(72) Inventor: Gauri Abhijeet GHOLAP, Santa Clara, CA (US)

(73) Assignee: OPTRA SYSTEMS INC., Santa Clara, CA (US)

(21) Appl. No.: 13/892,802

(22) Filed: May 13, 2013

(51) Int. Cl. G06T 7/00

(52) U.S. Cl. CPC G06T 7/0012
USPC 382/128

(57) ABSTRACT

A digital pathology imaging method may comprise receiving a plurality of image sections on a cloud server, the plurality of image sections being a result of splitting an initial digital image; stitching the plurality of image sections on the cloud server into a reconstituted digital image; and providing access to the reconstituted digital image. A system for digital pathology imaging may comprise a cloud server for receiving a plurality of image sections, wherein the cloud server comprises an image stitching module configured to stitch the plurality of image sections into a reconstituted digital image. Also, a system for digital pathology imaging may comprise: an image preprocessor configured to preprocess an initial digital image such that correct alignment of a plurality of tiles are enabled; an image splitter configured to split the initial digital images into a plurality of image sections with a stitching provision in pixels; and an asynchronous messaging module configured to push the plurality of image sections to the cloud server.

### BACKGROUND

Digital pathology is a process of converting glass microscopy slides into high-resolution digital images. These images can be viewed, managed, analyzed and interpreted with a computer-based digital pathology work flow management system, instead of a microscope. This process allows faster and more accurate analysis and reporting, easy archival and retrieval of stored images and metadata, and facilitates transfer of digitized slides over shared networks for consultations, second opinions, education and quality control.

Most of the digital pathology systems available in the market today view, process and store digital images using desk top-based and web-based solutions, resulting in solutions that are resource intensive, slow and unscaleable.

A few of the digital pathology systems currently use cloud-based resources for deployment of services and solutions. However, these solutions mainly apply to cloud-based image analysis and image management, and remote viewing of digital images with collaboration.

US patent application publication no. US 2013-0034279 A1 describes a method for viewing and analyzing pathology digital images on a cloud.

U.S. Pat. No. 8,244,912 describes a cloud-based system for networked digital pathology exchange.

### SUMMARY

According to one disclosed embodiment, a digital pathology imaging method may comprise: receiving a plurality of image sections on a cloud server, the plurality of image sections being a result of splitting an initial digital image; stitching the plurality of image sections on the cloud server into a reconstituted digital image; and providing access to the reconstituted digital image.

According to another disclosed embodiment, a system for digital pathology imaging may comprise a cloud server configured to receive a plurality of image sections, the plurality of image sections being a result of splitting an initial digital image. The cloud server comprises an image stitching module configured to stitch the plurality of image sections into a reconstituted digital image.

According to another disclosed embodiment, a system for digital pathology imaging may comprise: an image preprocessor configured to preprocess an initial digital image such that correct alignment of a plurality of tiles is enabled; an image splitter configured to split the initial digital image into a plurality of image sections with a stitching provision in pixels; and an asynchronous messaging module configured to push the plurality of image sections to the cloud server.

It is to be understood that both the foregoing general description and the following detailed descriptions are exemplary and explanatory only, and are not restrictive of the invention as claimed.

### BRIEF DESCRIPTION OF THE DRAWINGS

The features, aspects and advantages of the present invention will become apparent from the following description, appended claims, and the accompanying exemplary embodiments shown in the drawings, which are briefly described below.

FIG. 1 depicts a system for digital pathology slide imaging according to one embodiment of the present invention.

FIG. 2 depicts the image preprocessor module according to the embodiment of FIG. 1.

FIG. 3 depicts the image splitter module according to the embodiment of FIG. 1.

FIG. 4 depicts the asynchronous messaging module according to the embodiment of FIG. 1.

FIG. 5 depicts the scheduler module according to the embodiment of FIG. 1.

FIG. 6 depicts the image stitcher module according to the embodiment of FIG. 1.

FIG. 7 depicts a cloud-based process for digital pathology slide images according to one embodiment of the present invention.

### DETAILED DESCRIPTION

In the field of digital pathology, the images can be captured by digital cameras mounted on microscopes, by robotic/automated microscopes and by digital slide scanners. Output is generated, for example, as pathology digital images of selected fields of view as in the case of digital cameras or raw, unprocessed digital data in case of digital slide scanners. This output may need to be stitched, mosaicked and encoded to form complete digital images, and compressed to cause a reduction in size to allow for effective storage and transfer across networks. The massive size of the digitized images of glass slides makes stitching, processing, viewing, storing and sharing these images resource intensive in terms of bandwidth, network connectivity, storage space and time, when done locally or as a web-based method. Moreover, the hardware and software set up, configuration and maintenance required add to the resource intensiveness of the technology. There are also additional security and compliance issues involved while handling the images and related metadata. The access to the stored images and data is also limited and location bound.

As will be described, embodiments disclosed herein may provide a simple, scalable, secure, fast, minimally resource dependent method, for effective processing, managing and storing of images and metadata, with anytime-anywhere access to the same. This method is made possible by having the digital pathology images pre-processed, split into smaller components if necessary and transferred to a cloud for further stitching and processing with subsequent compression, viewing and analysis on a cloud-based image viewer and sharing on a cloud-based telepathology service. A cloud is a virtual network on one of more cloud servers, that may be private or public, which permits minimal end-user prerequisites like a work station and an internet connection. The systems and method according to embodiments of the present invention provide delivery of digital pathology processes in a “software as a service” (SAAS) model over the private and/or public clouds.

By using cloud-based technology to host these processes that form the backbone of the digital pathology work flow, systems and methods may be provided that are fast, scalable, and secure and overcomes resource limitations of hardware, bandwidth and network. Moreover being cloud-based, the systems and method are accessible to the user 24 hours a day, 7 days a week from any chosen place of work.

The applications for the cloud-based technology as described herein can include, but are not limited to, diagnostic applications, research and development, preclinical research, and/or any other application that involves the analysis of pathological specimens, such as in the pharmaceutical, medical, and/or scientific industries.

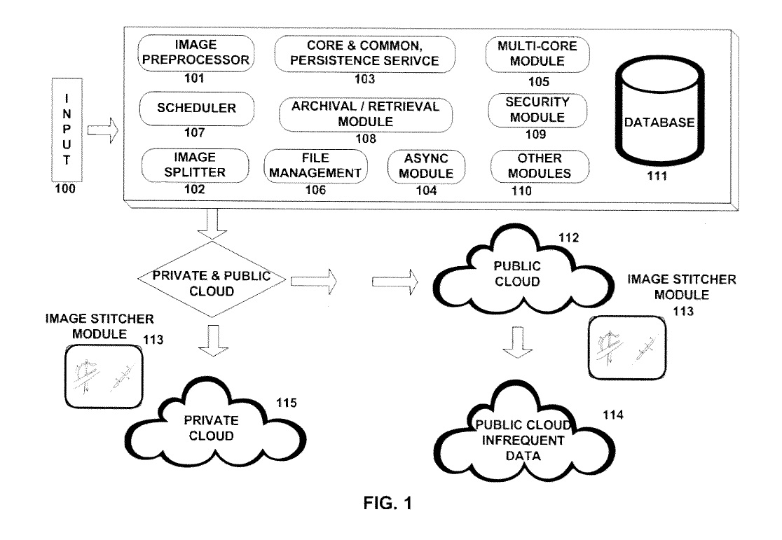

FIG. 1 depicts a system for digital pathology slide images according to one embodiment in which various modules are shown. The input 100 provides a whole image or pieces of an image in any form. For example, one or more glass slides can be converted into digital images using a digital camera mounted on a microscope, an automated/robotic microscope, a digital slide scanner, or any combination thereof. According to one embodiment, a digital slide scanner is used, which can use at least one of two different techniques for scanning slides. The first technique is area scanning, wherein the images are scanned to generate multiple frames, each frame consisting of a plurality of tiles, which comprises multiple pixels. The second technique is line scanning, wherein the images are scanned in a line-by-line manner, in which the lines or “swathes” comprise multiple pixels. The frames or lines/swathes so captured may then be systematically aligned together using a stitching and encoding mechanism to form a complete digital image. The images formed may be the result of bright field and/or fluorescence imaging, but is not limited to just these types of imaging.

The output from these sources, which forms the input 100, can be in the form of pathology digital images of fields of view acquired by a digital camera mounted on a microscope; unprocessed digital data in the form of frames comprising tiles, or lines/swathes (hereinafter referred to as “image sections/pieces” in any form) acquired by an area or line scanner, or an automated/robotic microscope; pathology digital images formed by stitching, mosaicking and encoding of frames and tiles/lines/swathes (hereinafter referred to as “sections/pieces” in any form) acquired by the digital slide scanner and/or automated/robotic microscope and processed locally; and/or pathology digital images acquired from any of these sources and stored/archived locally.

For example (though the invention is not limited to this example), depending on the size of the tissue scanned, the resolution and the objective used, the image size varies in a wide range. Typically pre-scan or thumbnail images giving an overall view of the entire slide are captured initially with a thumbnail camera. Slides are then scanned at magnifications ranging from 2× to 40×. At higher magnifications capture resolutions commonly vary from 0.5 microns/pixel (effective viewing magnification: 20×) to 0.275 microns/pixel (effective viewing magnification: 40×). For example, the image file associated with a 20× scan of a 15 mm×20 mm tissue specimen is as large as 3.6 GB and a 40× scanned image can be as large as 14.5 GB. The size of the image further increases as the size of the tissue and the scanning magnification increase.

Other types of input 100 are also contemplated. For example, the input 100 may be (1) unprocessed digital data in the form of lines and/or swathes, or frames composed of a plurality of tiles and image sections in any other form, generated by a digital whole slide scanner by scanning glass slides in the bright field and/or fluorescence mode; (2) static digital images captured by a digital camera mounted on a microscope; (3) from a robotic/automated microscope, in the form of raw data as tiles and frames or image sections in any other form, or processed whole images, in the bright field and/or fluorescence mode; and/or (4) previously stitched and processed digital images, from a robotic/automated microscope and/or a digital whole slide scanner or images obtained from a digital camera mounted on a microscope, and stored locally.

In certain systems, the massive size, speed of transfer and retrieval, and security and integrity issues of these generated images are major obstacles in adoption of the technology of digital pathology even though the images may be compressed to more manageable sizes (25:1 compression or greater). For example, the 20× scan could be stored in a JPEG2000-compression file of size 144 MB. The 40× image described above could be stored in a JPEG2000-compressed file of size 576 MB. However, in conventional systems, the stitching and processing, archival/retrieval, storage and transfer of these huge digital images across networks is resource intensive in terms of space, bandwidth, required hardware and software; translating to need for additional resources and loss in terms of scalability and speed for the end user. As will be described, the system and method according to embodiments disclosed herein provide innovative solutions for the input 100 that achieve an optimization between image quality, image file size, image processing, network bandwidth usage, and server and client resource utilization. As will be described later, the pathology digital images are further compressed and opened in an image viewer for viewing (with panning, zooming, annotating) and analyzing. As a result, the pathology digital images can then be shared, for consultations, archived and retrieved for reference in the future.

Referring back to FIG. 1, an image preprocessor module 101 may preprocess the image from the input. For example, pre-processing the image may include understanding the format, meta-data linked to the tile, tile information, etc. to enable the correct alignment of the plurality of tiles resulting in the efficient stitching of the tiles to form a complete digital image.

An image splitter module 102 may convert the whole image (that is, the input from the digital camera and/or line/area scanner, or a whole image stored locally) into tiles/lines/pieces (hereinafter referred to as “image sections” in any form) with an appropriate stitching provision in the pixels as expected by a stitching algorithm to reconstruct the whole image.

An asynchronous messaging module 104 may push the pathology digital image to a cloud server in an asynchronous manner. For example, the asynchronous messaging module 104 may push spooled image sections in various forms generated as unprocessed data by the whole slide scanner or digital images generated by a digital camera, robotic/automated microscope or digital slide scanner, residing locally, to the cloud for further processing and/or may pushed image sections/pieces generated by the image splitter 102.

An image stitching module 113 may reside on private and/or public cloud(s). The image stitching module 113 may be responsible for putting together all the spooled image sections in various forms to compose a whole digital image for further usage. The spooled images sections may be unprocessed data by the whole slide scanner or digital images generated by a digital camera, robotic/automated microscope or digital slide scanner, residing locally and/or may be image sections/pieces generated by the image splitter 102.

A core and commons persistence services module 103 may be for exception handling, logging, file input output etc. implementations.

A multi core module 105 may enable smart utilization of all available processors for doing appropriate tasks as per availability with the help of a preemption algorithm to take care of allocation of all the image sections/pieces in various forms streamed either from the scanner and/or the image splitting module on the cloud for further stitching, processing and viewing.

A file management module 106 may be for input output file reading/writing operations and networking.

A scheduler module 107 may include a timer module responsible for configuration and execution of timely jobs/tasks needed within an application.

An archival and retrieval module 108 may be for archival/retrieval of small image tiles to/from a preconfigured cloud server, which can be either public or private.

A security module 109 may encrypt and/or decrypt image pieces/ tiles/images while streaming/archiving/retrieving from the preconfigured cloud server, which can be either public or private.

Other modules 110 may be used to provide system event logging, auditing, monitoring, admin console, user interface etc. For example, an audit module may be used for auditing and monitoring all tasks as described herein for the disclosed methods and systems.

A database 111 may be used for maintenance of information regarding image meta-data, tile mapping, splitting details, and other utility options.

A private cloud 115 and public cloud 112,114 may be used for hosting data that is frequently needed (that is, more recent) and/or infrequently needed (that is, older), respectively.

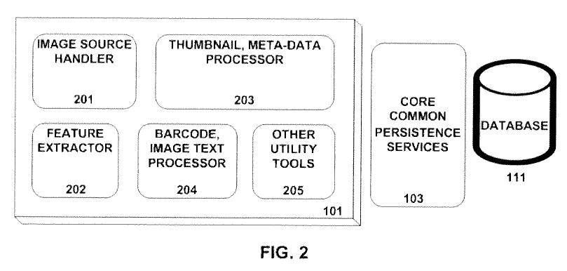

FIG. 2 depicts the image preprocessor module 101 of FIG. 1. The image preprocessor module may comprise an image source handler 201, a feature extractor 202, a thumb-nail and metadata processor 203, a barcode and image text processor 204, and/or other utility tools 20. The core and commons persistence services 103 is available for all the modules. Also, the database 111 is also available for maintenance of information regarding image meta-data, tile mapping, splitting details, and/or other utility options.

The image source handler 201 may be a utility component with intelligent powers to handle multiple image sources seamlessly and align them based on the image source.

The feature extractor 202 may be a component that extracts image features and applies these to a whole image on the cloud to ensure that all the features pertaining to the input image are preserved.

The thumb-nail and metadata processor 203 may process image thumbnail and metadata for further reference and retrieval by an image viewer.

The barcode and image text processor 204 may process bar-code or image texts separately while transferring them to the cloud.

The other utility tools 205 may include APIs and libraries used specifically for this module.

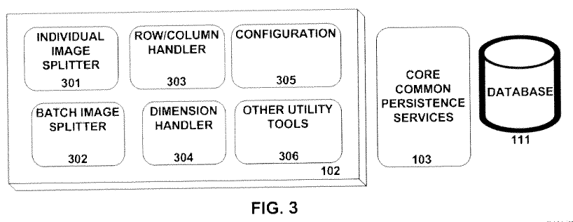

FIG. 3 depicts the image splitter module 102 of FIG. 1. The image splitter 102 may comprise an individual image splitter 301, a batch image splitter 302, a row/column handler 303, a dimension handler 304, a configuration module 305, and/or other utility tools 306. The core commons persistence services module 103 may be available for all the modules. Also, the database 111 is also available for maintenance of information regarding image meta-data, tile mapping, splitting details, and/or other utility options.

The individual image splitter 301 may be responsible for splitting individual images into tiles, lines or pieces.

The batch image splitter 302 may be responsible for splitting multiple images into various image sections.

The row/column handler 303 may allow user selection or pre-configuration for individual and batch splitting of images as per a selected number of rows and columns.

The dimension handler 304 may handle image dimensions, individual line/tile dimensions etc.

The configuration module 305 may be a component for configuration of all configurable items.

The other utility tools 306 may be utility tools needed to handle different image formats.

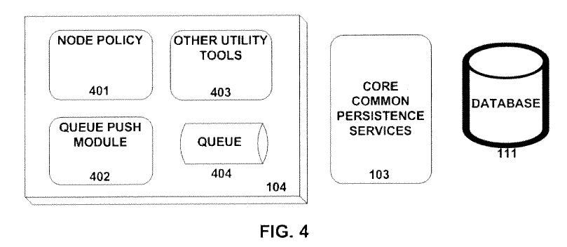

FIG. 4 depicts the asynchronous messaging module 104 of FIG. 1. The asynchronous messaging module may comprise a node policy module 401, a queue push module 402, a queue module 404, and/or other utility tools 403. The core and commons persistence services module 103 may be available for all the modules. The database 1 11 is for the maintenance of information regarding image meta-data, tile mapping, splitting details other utility options.

The node policy module 401 provides a governing policy for the installed node to communicate with the configured cloud URL over a secured protocol.

The queue push module 402 may enable pushing individual pieces to a preconfigured queue as split into by an individual/batch splitter.

The other utility tools 403 may be used when required.

The queue module 404 may form a queue populated with image sections and de-queue when image pieces are successfully uploaded to the target public cloud and/or private cloud.

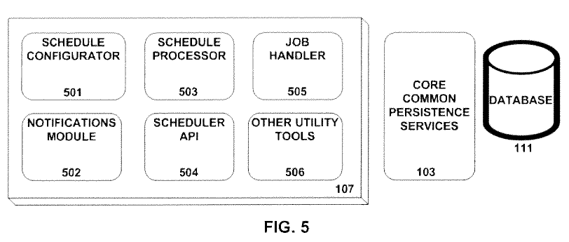

FIG. 5 depicts the scheduler module 107 of FIG. 1. The scheduler module 107 may comprise a schedule configurator 501, a notifications module 502, a schedule processor 503, a scheduler of APIs 504, a job handler 505, and/or other utility tools 506. The core and commons persistence services module 103 may be available for all the modules. The database 111 may be for the maintenance of information regarding image meta-data, tile mapping, splitting details other utility options.

The schedule configurator 501 may be a component that schedules a cloud upload at all hours to utilize complete bandwidth and processing capabilities.

The notifications module 502 may be a notification engine to generate different types of notifications like logs, emails, texts and automated calls.

The schedule processor 503 may be a component for executing all the scheduled jobs.

The scheduler of APIs 504 may be a component for scheduling APIs as and when needed. The scheduler may be integrated seamlessly into the system.

The job handler 505 may be a component that provides job templates to enable building scheduled jobs for execution.

The other utility tools 506 may be added to handle different image formats.

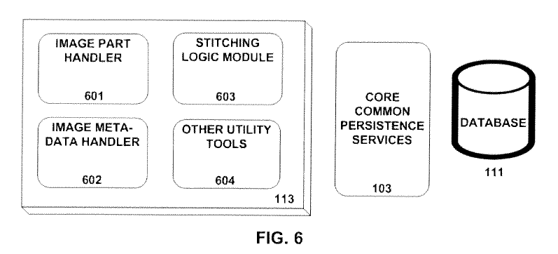

FIG. 6 depicts the image stitcher module 113 of FIG. 1, which resides in a cloud 115. The image stitcher module 113 may comprise an image part handler 601, an image meta-data handler 602, a stitching logic module 603, and/or other utility tools 604. The core and commons persistence services module 103 may be available for all the modules. The database 111 may be used for the maintenance of information regarding image meta-data, tile mapping, splitting details other utility options.

The image part handler 601 may be a component responsible for handling image pieces like tiles/lines and others.

The image meta-data handler 602 may be a component responsible for handling image features, meta-data after converting it to a whole image from individual image sections in various forms.

The stitching logic module 603 may be a component responsible for putting together all the image sections in various forms as delivered by the image splitter module 102 to form a whole digital image.

The other utility tools 604 may be used as needed to handle different image formats.

The system of FIGS. 1-6 may provide a digital pathology solution for transferring, splitting, stitching, processing, viewing, archiving and sharing of one or more pathology digital images generated from glass slides by a digital camera, a robotic and automated microscope, and/or a whole slide scanner (that may employ area or line scanning techniques). The input 100 to this solution may be directly from the digital camera, the robotic/automated microscope or the whole slide scanner, or from saved image folders residing locally. Private as well as public clouds 112, 114 and 115 may be used as platforms for the application depending on the nature of images and metadata, that is, more recent and older, in nature respectively.

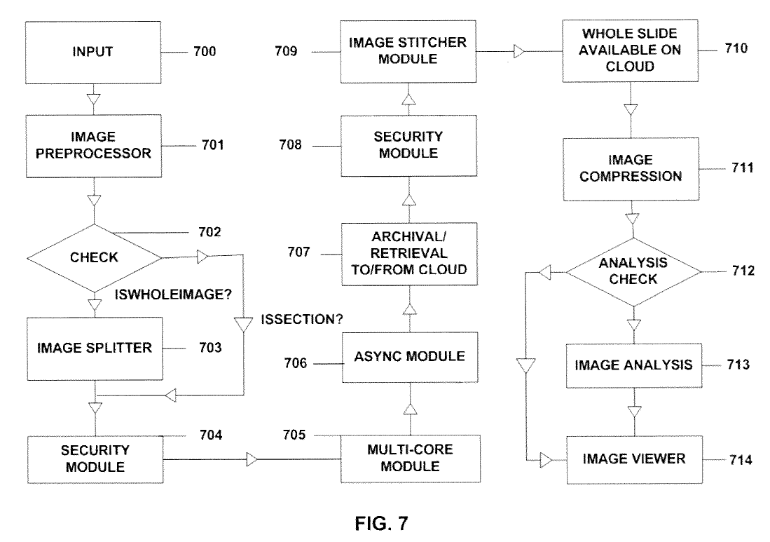

FIG. 7 is a flow chart of an embodiment of a method of processing digitized pathology slide images. One or more glass slides are scanned on a robotic/automated microscope, scanned on a whole slide digital scanner, or captured as digital images by a digital camera forming an input in the input step 700. The input in step 700 may be in one of a plurality of image sections/forms.

In processing step 701, an image preprocessor module 101 helps in the understanding of the image format, attached metadata, tile/line information etc. The image preprocessor module 101 is composed of an image source handler 201 that will allow the handling of a variety of image formats, aligning itself intelligently depending on the specific format. The feature extractor module 202 further extracts the features from these different images and stored in the database 111 for further reference and processing while stitching back to form a whole slide image. The thumbnail and metadata associated with the image will be processed and deciphered by the thumbnail and metadata processor 203. Any associated bar code and image text is processed by the barcode and image text processor 204.

In step 702, a check is performed to determine whether there are whole images, for example, as in the case of a digital camera or locally residing processed and stored images. In the case of whole images, in step 703, the image splitter module 102 breaks the images into multiple pieces, to ensure fast and efficient streaming to and storage on the cloud, and to define appropriate stitching provision in pixels so as to enable a stitching algorithm to reconstruct a whole image in the cloud. The image splitter module 102 has the capability of working on individual images using the individual image splitter 301 as well as batches of images using the batch image splitter 302. Rows, columns and individual dimensions of the images are handled by the row/column handlers 303 and dimension handlers 304.

In step 704, the security module 109 ensures the integrity, confidentiality and security of the unprocessed image sections in any form and metadata through encryption/decryption during the transfer from the image splitter 102 to the preconfigured public/private cloud server.

In step 705, multiple processors perform designated tasks and the multi core module 105 smartly utilizes all available processors for doing appropriate tasks on availability. This will ensure optimum speed of the entire process. A preemption algorithm will take care of the allocation of the tasks to the various processors.

In step 706, the asynchronous messaging module 104 pushes the digital image pieces/sections in various forms to the cloud using the queue push module 402. The scheduler module 107 will ensure round the clock cloud upload of the image sections in any form to optimally utilize bandwidth and processing capabilities.

Once a complete, compressed image is formed, in step 707, the archival and retrieval module 108 stores this image in one or more desired formats to the preconfigured private and/or public cloud server, and retrieve the stored images as and when necessary from the preconfigured private and/or public cloud server.

In step 708, the security module 109 ensures the integrity, confidentiality and security of the unprocessed image sections in any form and metadata through encryption/decryption during the archival and retrieval from the preconfigured public/private cloud server. Thus, the security module 109 may securely encrypt/decrypt the image/image pieces/components while performing archival/retrieval from the public and/or private preconfigured cloud server.

In step 709, the cloud-based stitching module 113 handles the images as well as the associated metadata. Once the split digital images in any mentioned form are ready to be stitched, the stitching module 113 will align and stitch the spooled image components/pieces to form a complete reconstituted digital image on the private/public clouds 112, 114, 115, as indicated in step 710. In step 711, the images will be compressed by an image compression module to reduce their size and allow effective and fast transfer, viewing, storage, retrieval and sharing. An algorithm for compression of the images may reduce the size of the stitched images. For example, a WEG2000-compression tile may be formed.

In step 712, an analysis check is performed to determine if the image needs to be analyzed before it is viewed. Image analysis algorithms in step 713 effectively assist in the accurate analysis of the image. A cloud-based image viewer in step 714 may effectively assist the easy viewing with panning, zooming, and/or annotation of the processed digital slide images. The images viewed and analyzed in the image viewer can be used to glean useful clinical information. Also, a cloud-based telepathology module may be added which can ensure efficient and speedy transfer of images for remote interpretations, corroborations, and consultations of the images.

As described, systems and methods for transferring digital pathology images to a cloud, after preprocessing and splitting them, for further stitching, processing, viewing, storing, managing and sharing these images on private and/or public clouds are disclosed. The images may be the result of bright field and fluorescence imaging, but not limited thereto. As a result, there are minimal end-user prerequisites like a work station and an internet connection that are needed.

Besides those embodiments depicted in the figures and described in the above description, other embodiments of the present invention are also contemplated. For example, any single feature of a disclosed embodiment (provided above or below) may be used in any other embodiment. For example, the following is a list of embodiments, but the invention should not be viewed as being limited to these embodiments.

(I) A digital pathology solution, for digital image preprocessing and splitting, transfer to and from the cloud for, cloud-based stitching, processing, secure archival and speedy retrieval, for anytime-anywhere cloud-based viewing (with panning and zooming), analysis and sharing of these digital images.

(II) The solution according to embodiment (I), wherein the input to the solution is unprocessed digital data in the form of lines/swathes, or frames composed of a plurality of tiles and image sections in any other form, generated by a digital whole slide scanner by scanning glass slides in the bright field and/or fluorescence mode.

(III) The solution according to embodiment (I), wherein the input to the solution may be static digital images captured by a digital camera mounted on a microscope.

(IV) The solution according to embodiment (I), wherein the input may be from a robotic/automated microscope, in the form of raw data as tiles and frames or image sections in any other form, or processed whole images, in the bright field and/or fluorescence mode.

(V) The solution according to embodiment (I), wherein the input to the solution may be previously stitched and processed digital images, from a robotic/automated microscope and/or a digital whole slide scanner or images obtained from a digital camera mounted on a microscope, and stored locally.

(VI) The solution according to embodiment (I), wherein an image preprocessor will help in preprocessing of image, that is, understanding the format, meta-data linked to the tile, tile information etc. to enable correct alignment of the plurality of tiles resulting in efficient stitching of the tiles to form a complete digital image for viewing.

(VII) The solution according to embodiment (I), wherein an image splitter would split the digital images into lines/frames or any other image section as required, with appropriate stitching provision in pixels, as expected by stitching algorithm to enable reconstruction of a whole digital image.

(VIII) The solution according to embodiments (I) or (VII), wherein a asynchronous messaging module will push spooled image sections in various forms generated as unprocessed data by the whole slide scanner or digital images generated by a digital camera, robotic/automated microscope or digital slide scanner, residing locally, to the cloud for further processing or image sections/pieces generated by the image splitter.

(IX) The solution according to embodiments (I), (III), or (VIII), wherein an image stitching module will be residing on a private and/or public cloud and will be responsible for stitching all the spooled images in any form; received from the digital slide scanner; or generated by the image splitter, and converting them into a whole image for further usage.

(X) The solution according to embodiment (I), wherein multiple processors do the plurality of tasks. A multi-core module that will smartly utilize all available processors for doing appropriate tasks on availability with the help of a preemption algorithm to take care of allocation of all the image sections/pieces in various forms streamed either from the scanner or image splitting module on the cloud for further stitching, processing and viewing.

(XI) The solution according to embodiment (I), wherein an algorithm for compression of the image reduces the size of stitched images, and facilitates efficient viewing, storage, retrieval and transfer.

(XII) The solution according to embodiment (I), further comprising a cloud-based image viewer for quick and effective viewing (with panning, zooming and annotation) of the processed digital slide images.

(XIII) The solution according to embodiment (I), further comprising a cloud-based image analysis solution to effectively analyze the images viewed in the image viewer and glean useful clinical information.

(XIV) The solution according to embodiment (I), further comprising a cloud-based telepathology module to ensure speedy and effective collaboration and remote interpretation of the images.

(XV) The solution according to embodiment (I), further comprising a security module that will securely encrypt/decrypt the image /image pieces/components while archival/retrieval from the preconfigured cloud server (public/private).

(XVI) The solution according to embodiment (I), further comprising an archival module that will archive/retrieve the image to/from the preconfigured cloud server (public or private).

(XVII) The solution according to embodiment (I), further comprising an audit module for auditing and monitoring all tasks mentioned in the embodiments of (I) to (XII).

What is claimed is:

1. A digital pathology imaging method, comprising steps of:
receiving a plurality of image sections on a cloud server, the plurality of image sections being a result of splitting an initial digital image;
stitching the plurality of image sections on the cloud server into a reconstituted digital image; and
providing access to the reconstituted digital image.

2. The digital pathology imaging method according to claim 1, further comprising securely archiving the reconstituted digital image on the cloud server.

3. The digital pathology imaging method according to claim 1, wherein the step of providing access to the reconstituted digital image comprises retrieving the reconstituted digital image from the cloud server.

4. The digital pathology imaging method according to claim 1, wherein the step of providing access to the reconstituted digital image comprises providing cloud-based viewing of the reconstituted digital image on a cloud-based viewer.

5. The digital pathology imaging method according to claim 1, wherein the step of providing access to the reconstituted digital image comprises analyzing the reconstituted digital image.

6. The digital pathology imaging method according to claim 1, wherein the step of providing access to the reconstituted digital image comprises sharing of the reconstituted digital image.

7. The digital pathology imaging method according to claim 1, wherein the initial digital image is preprocessed before being split and received on the cloud server.

8. The digital pathology imaging method according to claim 1, wherein the initial digital image is a result of scanning a glass slide in a bright field mode, a fluorescence mode, or a combination thereof by a digital whole slide scanner, which generates one of (1) unprocessed digital data in a form of lines or swathes and (2) frames comprising a plurality of tiles.

9. The digital pathology imaging method according to claim 1, wherein the initial digital image is a result of one of (1) a static digital image captured by a digital camera mounted on a microscope, (2) raw data from a robotic/automatic microscope, and (3) a previously stitched and processed digital image.

10. A system for digital pathology imaging, comprising:
a cloud server configured to receive a plurality of image sections, the plurality of image sections being a result of splitting an initial digital image,
wherein the cloud server comprises an image stitching module configured to stitch the plurality of image sections into a reconstituted digital image.

11. The system according to claim 10, wherein the cloud server further comprises an image compression module for compressing the reconstituted digital image.

12. The system according to claim 10, wherein the cloud server further comprises a cloud-based image viewer configured to permit viewing the reconstituted digital image.

13. The system according to claim 10, wherein the cloud server further comprises a cloud-based telepathology module configured to transmit the reconstituted digital image to one or more remote locations.

14. The system according to claim 10, further comprising:
an image preprocessor configured to preprocess the initial digital image such that correct alignment of a plurality of tiles is enabled;
an image splitter configured to split the initial digital image into the plurality of image sections with a stitching provision in pixels;
an asynchronous messaging module configured to push the plurality of image sections to the cloud server; and
a security module configured to encrypt, decrypt, or a combination thereof the plurality of image sections while sending the plurality of image sections to or retrieving the plurality of image sections from the cloud server.

15. A system for digital pathology imaging, comprising:
an image preprocessor configured to preprocess an initial digital image such that correct alignment of a plurality of tiles is enabled;
an image splitter configured to split the initial digital image into a plurality of image sections with a stitching provision in pixels; and
an asynchronous messaging module configured to push the plurality of image sections to the cloud server.

16. The system according to claim 15; further comprising a security module configured to encrypt, decrypt, or a combination thereof the plurality of image sections while sending the plurality of image sections to the cloud server or retrieving the plurality of image sections from the cloud server.

17. The system according to claim 15, further comprising the cloud server for receiving the plurality of image sections, wherein the cloud server comprises an image stitching module configured to stitch the plurality of image sections into a reconstituted digital image.

18. The system according to claim 17, wherein the cloud server further comprises an image compression module for compressing the reconstituted digital image, a cloud-based image viewer configured to view the reconstituted digital image, and a cloud-based telepathology module configured to permit transmission of the reconstituted digital image to one or more remote locations.
